(19) United States
(12) Patent Application Publication
(10) Pub. No.: US 2026/0342446 A1
(43) Pub. Date: Oct. 29, 2026

(54) SYSTEM FOR EMITTING AND RECEIVING A LIGHT BEAM IN A MOTOR VEHICLE

(71) Applicant: VALEO VISION, Bobigny (FR)

(72) Inventors: Pierre RENAUD, Bobigny (FR); Mickael MIMOUN, Bobigny (FR); Hafid EL-IDRISSI, Bobigny (FR); Jose AFONSO, Bobigny (FR); Sidahmed BEDDAR, Bobigny (FR); Pierre ALBOU, Bobigny (FR)

(73) Assignee: VALEO VISION, Bobigny (FR)

(21) Appl. No.: 19/116,132

(22) PCT Filed: Sep. 27, 2023
(86) PCT No.: PCT/EP2023/076645

§ 371 Date: Mar. 27, 2025

(30) Foreign Application Priority Data
Sep. 28, 2022 (FR) FR2209843

(51) Int. Cl. H04B 10/524; B60Q 1/04; H05B 47/11

(52) U.S. Cl. CPC H04B 10/524; B60Q 1/04; H05B 47/11

(57) ABSTRACT

The invention relates to a system including an emission module with a luminous module able to emit a light beam, the spectrum of the light beam has at least one portion in the visible spectrum, and a linear polarizer device arranged to polarize the light beam in a given polarization direction, and a reception module able to receive a light beam. The reception module includes an elementary acquisition module with a photodetector able to convert a light signal that the photodetector receives into an electrical signal. The reception module also includes a linear polarizer filter arranged to only transmit the component of the received light beam to the elementary acquisition module that is polarized in the given polarization direction.

### TECHNICAL FIELD

The invention relates to the field of automotive lighting and data transmission functions using the light emitted by an automotive lighting system. More specifically, the invention relates to a system for an automotive vehicle for receiving data transmitted by a light beam.

### BACKGROUND OF THE INVENTION

In the automotive field, it is known for a light beam emitted by a luminous module to be used both to perform a given photometric function and to transmit data.

Conventionally, the light source used to emit this light beam is controlled by a pulse-width-modulated (PWM) electrical signal. The light source is thus periodically activated and deactivated by this PWM signal, so that the emitted light beam is composed of successive light pulses with a frequency that is high enough that the human eye no longer distinguishes them. The intensity of the emitted light beam depends on the duty cycle of this PWM signal, enabling said intensity to be controlled by adjusting this duty cycle. This PWM signal then can be modulated using a data sequence so that this data sequence is conveyed by the light beam. In this way, the light beam can retain its original function, namely, to perform a photometric function, while allowing the data sequence to be conveyed. This type of technology is known, for example, as visible light communication (VLC), or also light fidelity (LiFi).

Thus, beyond performing one or more photometric functions, such as a daytime running lamp or low-beam lighting, various functions can be implemented by this type of luminous module. For example, the luminous module thus can be integrated into an emission module able to perform functions involving communicating a data sequence with another vehicle or with a piece of infrastructure that is equipped with a reception module able to demodulate the received light beam in order to extract the data sequence therefrom. In another example, the headlight comprising the emission module can be equipped with a reception module in order to receive the emitted light beam, following its reflection on an object in the vicinity of the vehicle. It is then possible, by demodulating and extracting the transmitted data sequence, to determine the time-of-flight of the emitted light beam and thus evaluate the distance separating the vehicle from the object.

However, this type of system based on the use of an emission module able to perform both a photometric light function and data transmission function has a drawback. Indeed, the reception module intended to receive the light beam conveying the data, whether it is arranged in the same vehicle or in another vehicle, must comprise at least one photodetector for converting this light beam into an electrical signal in order to demodulate this signal and extract a data sequence therefrom.

However, under certain conditions, the signal-to-noise ratio of this photodetector can be significantly degraded. This is notably the case in abundant sunshine conditions. Indeed, under such conditions, the light from the sun, in the visible spectrum in which the light source of the emission module operates, can be substantially greater than the light from the received light beam, thereby saturating the photodetector. In this state, the photodetector enters a non-linear operating state and is unable to adequately convert the light beam into an electrical signal that can be demodulated without loss of information.

Therefore, a requirement exists for a system able to transmit a data sequence, from an emission module incorporating a luminous module involved in performing a photometric function to an acquisition module, in which the signal-to-noise ratio is optimal in all weather conditions, including abundant sunshine.

### SUMMARY OF THE INVENTION

The present invention falls within this context, and aims to address this requirement.

To this end, the aim of the invention is a system for an automotive vehicle, comprising:
a. an emission module comprising a luminous module able to emit a light beam, the spectrum of which has at least one portion in the visible spectrum, and a linear polarizer device arranged to polarize said emitted light beam in a given polarization direction;
b. a reception module able to receive a light beam, wherein the reception module comprises an elementary acquisition module comprising a photodetector able to convert a light signal that it receives into an electrical signal, characterized in that the reception module comprises a linear polarizer filter arranged to only transmit the component of said received light beam to the elementary acquisition module that is polarized in said given polarization direction.

As indicated above, under abundant sunshine conditions, the sunlight is added to the light emitted by an emission module, which can saturate the one or more photodetectors of the reception module. However, sunlight is generally not or is hardly polarized. In other words, half of this light is polarized in a polarization direction P, while the other half of this light is polarized in the other polarization direction S.

Furthermore, linearly polarized light retains its specular polarization after reflecting on a surface. However, the different cases of use considered by the invention either aim for emission without reflecting the light, for the case of communication functions, or for specular reflections on surfaces of objects to be detected.

Therefore, it is understood that the light beam received by the reception module is composed of light polarized in said polarization direction provided by the linear polarizer device and, in the case of abundant sunshine, of non-polarized light. The linear polarizer filter then allows the component of the polarized sunlight in the other polarization direction to be removed, so that the amount of sunlight arriving on the photodetector is divided by two. The saturation of the one or more photodetectors of the reception module is thus avoided in the case of abundant sunshine and the signal-to-noise ratio is thus multiplied by two.

In one embodiment of the invention, the luminous module is able to emit a light beam whose spectrum has a peak at a wavelength in the visible domain, notably between 400 nm and 500 nm. Advantageously, the luminous module comprises a light source comprising a semiconductor generator able to emit an elementary light beam, notably whose spectrum has a peak at a wavelength in the visible domain, and a photoluminescent element able to convert said elementary light beam in order to obtain said light beam.

The semiconductor can be, for example, made of gallium nitride, or even GaN, able to emit, by electroluminescence and in response to an electric current passing through it, blue light rays. The photoluminescent element can be, for example, in the form of a resin comprising cerium-doped yttrium aluminum garnet (CE:YAG), able to absorb blue light and, by photoluminescence and in response to excitation by this light, to emit yellow light rays. The photoluminescent element is arranged on the generator in such a way that a portion of the blue light rays excites this element so that it emits, by photoluminescence, yellow light rays. The other portion of the blue light rays passes through this element. Thus, the light source simultaneously emits, when it is electrically powered, blue and yellow light rays, with the light thus formed appearing white to the human eye.

The light source thus can be a laser source, a light emitting diode, a vertical-cavity surface-emitting laser (VCSEL) or even a superluminescent diode (SLED).

Advantageously, the luminous module can comprise an optical unit arranged to project the light rays emitted by the light source in order to form said light beam. Provision can be made for the linear polarizer device to be arranged between the light source and the optical unit or arranged downstream of said optical unit.

In one embodiment of the invention, the linear polarizer device comprises a semi-reflective plate arranged downstream of the luminous module and inclined at the Brewster angle relative to the emission axis of said luminous module.

In another embodiment of the invention, the linear polarizer device comprises a grid polarizer.

If so desired, the linear polarizer device can comprise a linear polarizer arranged to transmit a portion of the emitted light beam by polarizing it in said given polarization direction and to reflect another portion of the emitted light beam by polarizing it in the other polarization direction and an optical delay element arranged to receive said other portion and to polarize it in said given polarization direction. An optical delay element is understood to mean an optical element able to introduce a phase delay between the P and S components of the light, and in this case a 180° phase delay, thereby changing the polarization direction of linearly polarized light. It is thus possible to polarize, using the same component, substantially all the light emitted by the luminous module and therefore to maximize the yield of the linear polarizer device.

In this example, the linear polarizer can be a semi-reflective plate inclined at the Brewster angle relative to the emission axis of the luminous module or a grid polarizer. The optical delay element can be, for example, a half-wave plate or even a pair of Fresnel rhomb prisms. If applicable, the linear polarizer device can comprise at least one optical bypass element, such as a flat mirror, arranged downstream of the linear polarizer or between the linear polarizer and the optical delay element or downstream of the optical delay element, such that said portion of the light beam emitted by the linear polarizer and said portion polarized by the optical delay element are emitted in the same direction.

Preferably, the first linear polarizer device is arranged to polarize said emitted light beam in the polarization direction P.

Indeed, it has been found that, under certain conditions, sunlight can be polarized in a polarization direction S. This is the case, for example, when the sun is low, at dawn or dusk, and that its light is reflected by a reflective surface inclined at the Brewster angle, such as a water puddle. Under these conditions, it is therefore advantageous to favor a polarization of the emitted light beam in the polarization direction P in order to avoid saturation of the photodetector.

Advantageously, provision can be made for the linear polarizer filter to comprise a linear polarizer such as a semi-reflective plate inclined at the Brewster angle relative to the optical axis of the reception module or a grid polarizer, said linear polarizer being arranged upstream of the elementary acquisition module.

In one embodiment of the invention, the reception module comprises a plurality of elementary acquisition modules, each comprising a photodetector able to convert a light signal that it receives into an electrical signal.

For example, the set of photodetectors can form a sensor, for example, a single electronic component.

Advantageously, the photodetector of the or each elementary acquisition module is an avalanche photodiode. This type of photodetector is also known as a single-photon avalanche diode (SPAD). The set of avalanche photodiodes can thus form a silicon photomultiplier (SiPM). This type of photodetector can detect the incidence of a single photon with high gain, for example, of the order of 106, and thus compensate for the degradations of the signal-to-noise ratio due to the external conditions or even to the absorptions by the filters.

According to one embodiment of the invention, the reception module can comprise an optical unit arranged in front of the elementary acquisition module. Provision can be made for the linear polarizer filter to be arranged between the elementary acquisition module and the optical unit or for it to be arranged upstream of said optical unit.

In one embodiment of the invention, the emission module comprises a modulation unit able to receive a data sequence and arranged to modulate said emitted light beam from the received data sequence and the reception module comprises a demodulation unit connected to the photodetector and arranged to extract a data sequence from an electrical signal converted by this photodetector.

Advantageously, the modulation unit is arranged to generate a pulse-width-modulated control signal, to modulate said control signal using the received data sequence, and to control the emission of said light beam by the luminous module from the modulated control signal. For example, the modulation unit can be arranged to convert said received data sequence into a modulating signal and to modulate, for example, by amplitude, frequency or phase, the control signal with this modulating signal.

If applicable, the modulation unit can be arranged to control the light source, and notably an electrical power supply to this light source, in order to modulate the light beam.

Advantageously, the system comprises a computation unit arranged to detect, in a data sequence extracted by the demodulation unit from an electrical signal converted by the photodetector from a light beam received by the reception module, the presence of a data sequence modulating the light beam emitted by the emission module and to determine a time-of-flight separating the emission of said emitted light beam from the reception of said received light beam.

Advantageously, the emission module is arranged such that the light beam fully or partially participates in the completion of a predetermined statutory photometric function. It can be, for example, a daytime running lamp (DRL), which has the advantage of being emitted over a wide field at a low intensity.

Advantageously, the reception module and the emission module are arranged in a front headlight of the automotive vehicle.

A further aim of the invention is a front headlight of an automotive vehicle comprising a reception module and an emission module of a system according to the invention.

### BRIEF DESCRIPTION OF DRAWINGS

The present invention will now be described using examples that are only illustrative and by no means limit the scope of the invention, and with reference to the appended drawings, in which drawings the various figures show:

FIG. 1 schematically and partially shows a view of a system of an automotive vehicle according to one embodiment of the invention;

FIG. 2 schematically and partially shows an embodiment of a linear polarizer device of the system in FIG. 1.

### DETAILED DESCRIPTION OF THE INVENTION

Throughout the following description, elements that are identical in terms of structure or function and that appear in the various figures use the same reference signs, unless otherwise specified.

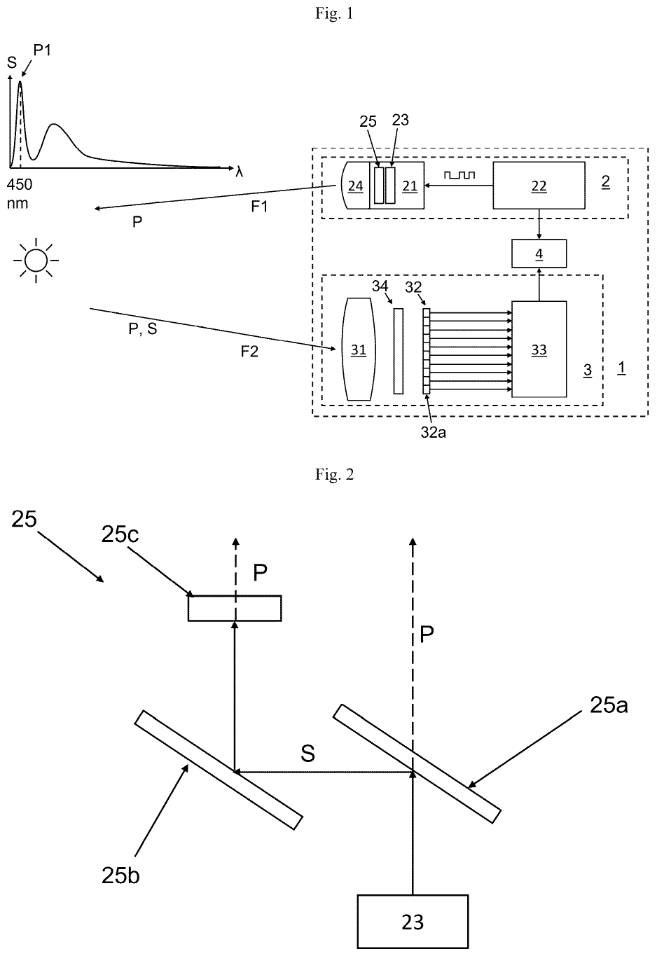

FIG. 1 shows a system 1 for an automotive vehicle according to one embodiment of the invention.

The system 1 comprises an emission module 2 arranged to emit a light beam F1 and a reception module 3 intended to receive a light beam F2.

In the example described, the emission module 2 and the reception module 3 are arranged in the same front headlight of the automotive vehicle. Provision can be made for the modules 2 and 3 to be arranged at different locations in the automotive vehicle, without departing from the scope of the present invention.

The emission module 2 comprises a luminous module 21 and a modulation unit 22.

The luminous module 2 is arranged so that the light beam F1, which it emits, has an electromagnetic spectrum S, at least one portion of which is located in the visible spectrum. As shown in FIG. 1, the spectrum S has a blue intensity peak P1, or ray at 450 nm. It should be noted that the spectrum S has other intensity peaks, in the visible and/or in the infrared domain.

In order to emit this light beam F1, the luminous module 21 comprises a light source 23 able to emit light rays and an optical unit 24 arranged to project these light rays in order to form the light beam F1. In the invention, the optical unit 24 can equally comprise one or more reflectors, one or more lenses, one or more diaphragms, or one or more collimators, or even a combination of several of these optical elements.

The light source 23 comprises, for example, a semi-conductor generator (not shown), for example, gallium nitride or even GaN, able to emit, by electroluminescence and in response to an electric current passing through said generator, blue light rays with an emission peak at 450 nm. The light source also comprises a photoluminescent element, in the form of a resin comprising cerium-doped yttrium aluminum garnet (CE:YAG), able to absorb blue light and, by photoluminescence and in response to excitation by this light, to emit yellow light rays.

The photoluminescent element is arranged on the generator in such a way that a portion of the blue light rays excites this element so that it emits, by photoluminescence, yellow light rays. The other portion of the blue light rays passes through this element. Thus, the light source 23 simultaneously emits, when it is electrically powered, blue and yellow light rays, with the light thus formed appearing white to the human eye.

Insofar as the light beam F1 is partially or fully composed of white light, it is possible to use this light beam F1 to partially or fully participate in the completion of a predetermined photometric function, notably a statutory function. In this case, the optical unit 24 is arranged to shape this light beam F1 so that the photometric distribution thereof satisfies the requirements of said function. For example, provision can be made for the light beam F1 to participate in the completion of a daytime running lamp (DRL) function.

In addition to this photometric function, the light beam F1 allows the system 1 to perform functions of detecting and evaluating the position of an obstacle on the road and/or of communicating with another vehicle or with a piece of road infrastructure.

The modulation unit 22 is able to receive a data sequence, for example, a predetermined sequence where it is used to detect and evaluate the position of an obstacle, with the sequence in this case being stored in a memory of the system 1 (not shown) or, as a variant, generated by a computer of the system 1 (not shown) to communicate with a system identical to the system in FIG. 1 provided in another vehicle or in a piece of road infrastructure.

The modulation unit 22 is arranged to modulate the light beam F1 emitted by the luminous module 21, using this data sequence, for example, by controlling the electrical power supply to the light source 23.

For these purposes, the modulation unit 22 comprises a pulse-width-modulated control signal generator. This control signal is used to control a switched-mode power supply (not shown) of the light source 23. Conventionally, the duty cycle of this control signal, set by the modulation unit 22, is therefore used to control the average electric power supplied to the light source 23, and therefore to control the luminous intensity of the light beam F1, in order to satisfy the requirements of the photometric function it performs.

In the example described, the modulation unit 22 is arranged to convert the data sequence into a modulating signal and to modulate the initial control signal using this modulating signal. It should be noted that several types of modulation can be equally employed within the scope of the present invention, and notably on-off-keying (OOK) modulation, pulse code modulation (PCM), pulse amplitude modulation (PAM), pulse width modulation (PWM), or even pulse position modulation (PPM).

When using the detection and the evaluation of the position of an obstacle, provision can be made for the data sequence to be a binary signal exhibiting different predetermined features, notably such as an autocorrelation peak for a zero temporal shift and/or low autocorrelation values for a non-zero temporal shift and/or a significant length, with these features allowing the signal-to-noise ratio of the system to be improved, and/or a Hamming weight, such that the average light intensity level of the emitted light beam remains substantially unchanged during its modulation with the data sequence. Such a sequence can be generated, for example, by means of a random code or pseudo-random code generation algorithm.

The light beam F1 thus emitted is composed of a train of successive light pulses with a sufficiently high frequency, for example, greater than 30 MHz, notably ranging between 50 MHz and 100 MHz, so that the human eye can no longer distinguish them. Furthermore, the amplitude, width and/or position of each pulse with respect to the period allows the light beam F1 to convey the data sequence to the reception module 3.

The reception module 3 comprises an optical unit 31, downstream of which a plurality of elementary acquisition modules 32 are provided. The reception module 3 further comprises a demodulation unit 33.

Each of the elementary acquisition modules 32 comprises a photodetector 32a. The light beam F2 received by the reception module 3 is thus concentrated by the optical unit 31 on one or more of the photodetectors 32a.

The light beam F2 can equally be the light beam F1 emitted by the emission module 2 and reflected by an obstacle or an object located in the environment of the vehicle toward the reception module 3, or a light beam emitted by an emission module of a system of another vehicle or a piece of road infrastructure equipped with an emission module similar to the module 2.

The photodetectors 32a are identical and are each formed by an avalanche photodiode of a silicon photomultiplier. These photodiodes are distributed in an array. It should be noted that the dimensions of the photodetectors 32a are in the micrometer range. The assembly thus forms a sensor, the reception spatial resolution of which is of the order of 0.1°, and the detection capabilities of which are particularly high, even in degraded acquisition conditions, due to the use of avalanche photodiodes.

Each of the photodetectors converts the portion of the light beam F2 that it receives into an electrical signal that it transmits to the demodulation unit 33, which can then extract a data sequence therefrom.

Where the system 1 implements a communication function, this data sequence then can be transmitted to a computer of the vehicle in order to be interpreted, decoded and/or transmitted to equipment or to a user of the vehicle.

Where the system 1 implements a function of detecting and evaluating the position of an object or of an obstacle, this data sequence can be transmitted to a computation unit 4 of the system 1. This computation unit 4 can thus detect therein the presence of a predetermined data sequence with which the modulation unit 22 has modulated the light beam F1 emitted by the luminous module 21. In this case, the computation unit can determine a time-of-flight between the emission of the light beam F1 and the reception of the light beam F2.

When the sunshine conditions in the vicinity of the vehicle are particularly bright, the sunlight is thus added to the light beam F2 received by the reception module 3. The light from the sun, in the visible spectrum, is significantly brighter than the light from a photometric function such as a daytime running lamp.

Consequently, the light beam F2 received by the reception module 3 is firstly composed of the light beam F1 emitted by the emission module 2, or by another similar emission module, and sunlight. The intensity levels of this beam F2 far exceed those of the beam F1 for the wavelength ranges in the visible domain.

In order to avoid saturation of the photodetectors 32a, the emission module 2 comprises a linear polarizer device 25.

In the example described, the linear polarizer device 25 is arranged between the light source 23 and the optical unit 24. Provision can be made to arrange this device 25 in other locations of the emission module, such as downstream of the optical unit 24, without departing from the scope of the present invention.

This linear polarizer device 25 is arranged to polarize the light of the beam F1 in a preferred polarization direction, namely, the direction P.

FIG. 2 shows a linear polarizer device 25, according to one embodiment of the invention.

The device 25 comprises a linear polarizer 25a, produced in the form of a semi-reflective plate arranged upstream of the light source 23 and inclined at the Brewster angle relative to the emission axis of this light source 23. The linear polarizer 25a is thus able to emit a portion of the light emitted by the light source 23, by polarizing it in the polarization direction P, and to reflect the other portion of this light by polarizing it in the polarization direction S.

A flat mirror 25b is arranged downstream of the light reflected by the plate 25a in order to reflect this light in the same direction as the light transmitted by the plate 25a.

A half-wave plate 25c is arranged downstream of the flat mirror 25b. This half-wave plate 25c is able to introduce a 180° phase delay between the P and S components of the light. With the light reflected by the flat mirror 25b being generally polarized in the direction S, it is thus polarized, at the output of the half-wave plate 25c, in the direction P.

It is thus understood that the device 25 described in FIG. 2 allows substantially all the light emitted by the light source 23 to be polarized in the direction P.

Other embodiments of the device 25 can be designed, for example, by using other optical components, such as grid polarizers or Fresnel rhomb prisms. It is also possible to simplify the design of the device 25, using a single linear polarizer. The device 25 also can be designed to polarize the light from the source 25 in the direction S rather than the direction P.

As shown in FIG. 1, the light of the light beam F1 is thus substantially polarized in the polarization direction P. Therefore, when this light beam F1 is reflected by an obstacle with specular reflection, it retains its polarization. In other words, the component of the light beam F2 received by the reception module 3, which corresponds to the light beam F1 emitted by the emission module 2, or by another similar emission module, is polarized in the direction P.

However, sunlight is generally not or is hardly polarized. In other words, half the component of the light beam F2 corresponding to sunlight is polarized in the polarization direction P, and the other half is polarized in the other polarization direction S.

The reception module 3 thus comprises a linear polarizer filter 34. In the example described, the linear polarizer filter 34 is arranged between the optical unit 31 and the elementary acquisition modules 32. Provision can be made to arrange this device 25 at other locations of the reception module, such as upstream of the optical unit 31, without departing from the scope of the present invention.

The filter 34 is arranged to only transmit the component of said light beam F2 to the elementary acquisition modules 32 that is polarized in the same polarization direction as that of the light beam F1.

Provision can be made for the linear polarizer filter 34 to comprise a linear polarizer such as a semi-reflective plate inclined at the Brewster angle with respect to the optical axis of the optical unit 31 or a grid polarizer.

It is thus understood that the filter 34 allows the component of the light beam F2 to be eliminated that is polarized in the direction S, which is only due to the sun. In this way, only half the sunlight is received by the photodetectors, such that saturation of these photodetectors 32a is thus avoided.

The above description clearly explains how the invention achieves its set objectives, namely, providing a system for an automotive vehicle capable of performing communication or detection functions from visible light and whose signal-to-noise ratio is optimal irrespective of the weather conditions, including in case of abundant sunshine. These objectives are notably achieved using an emission module and a reception module each equipped with the polarizer devices. These devices allow the sun-related signal-to-noise ratio to be significantly reduced, given the fact that sunlight is not polarized.

In any event, the invention is not limited to the embodiments specifically described in this document and particularly extends to all equivalent means and to any technically operative combination of these means. In particular, other types of light source than the one described, such as a laser diode, a VCSEL or a SLED, can be used. Photometric functions other than the one described also can be performed, and notably low-beam lighting functions or position-light signaling functions. Other configurations of the linear polarizer device and/or of the linear polarizer filter also can be provided.

What is claimed is:

1. A system for an automotive vehicle, comprising:
a. an emission module including a luminous module able to emit a light beam, the spectrum of the emitted light beam has at least one portion in the visible spectrum, and a linear polarizer device arranged to polarize the emitted light beam in a given polarization direction; and
b. a reception module able to receive a light beam, the reception module includes an elementary acquisition module with a photodetector able to convert a light signal that it receives into an electrical signal, and a linear polarizer filter arranged to only transmit the component of the received light beam to the elementary acquisition module that is polarized in the given polarization direction.

2. The system as claimed in claim 1, wherein the linear polarizer device includes a semi-reflective plate arranged downstream of the luminous module and inclined at the Brewster angle relative to the emission axis of the luminous module.

3. The system as claimed in claim 1, wherein the linear polarizer device includes a grid polarizer.

4. The system as claimed in claim 1, wherein the linear polarizer device includes a linear polarizer arranged to transmit a portion of the emitted light beam by polarizing it in the given polarization direction and to reflect another portion of the emitted light beam by polarizing it in the other polarization direction and an optical delay element arranged to receive the other portion and to polarize it in the given polarization direction.

5. The system as claimed in claim 1, wherein the linear polarizer device is arranged to polarize the emitted light beam in the polarization direction.

6. The system as claimed in claim 1, wherein the emission module includes a modulation unit able to receive a data sequence and arranged to modulate the emitted light beam from the received data sequence and the reception module includes a demodulation unit connected to the photodetector and arranged to extract a data sequence from an electrical signal converted by the photodetector.

7. The system as claimed in claim 6, wherein the modulation unit is arranged to generate a pulse width modulated control signal, to modulate the control signal from the received data sequence and to control the emission of the light beam by the luminous module from the modulated control signal.

8. The system as claimed in claim 6, further comprising a computation unit arranged to detect, in a data sequence extracted by the demodulation unit from an electrical signal converted by the photodetector from a light beam received by the reception module, the presence of a data sequence modulating the light beam emitted by the emission module and to determine a time-of-flight separating the emission of the emitted light beam from the reception of the received light beam.

9. The system as claimed in claim 1, wherein the emission module is arranged such that the light beam fully or partially participates in the completion of a predetermined statutory photometric function.

10. The system as claimed in claim 1, wherien the emission module and the reception module are arranged in a front headlamp of the automotive vehicle.
